(19) United States
(12) Patent Application Publication
(10) Pub. No.: US 2025/0108557 A1
(43) Pub. Date: Apr. 3, 2025

(54) Additive Manufacturing Composition

(71) Applicant: ExxonMobil Technology and Engineering Company, Spring, TX (US)

(72) Inventors: Ning Ma, Basking Ridge, NJ (US); Jaspal Singh Baljindar Singh, Singapore (SG); Ser Hor Chong, Futian (CN); Changmin Chun, Raritan, NJ (US); Thomas S. Copeland, League City, TX (US); Chee Lup Khong, Singapore (SG); Hans R. Söderberg, Sandviken (SE); Johan A. Wallin, Gävle (SE); Paul A. Davies, Swansea (GB)

(21) Appl. No.: 18/825,881

(22) Filed: Sep. 5, 2024

Related U.S. Application Data
(60) Provisional application No. 63/586,754, filed on Sep. 29, 2023.

(51) Int. Cl. B29C 64/165; B29C 64/176; B29C 64/205

(52) U.S. Cl. CPC B29C 64/165; B29C 64/176; B29C 64/205; B29K 2905/12

(57) ABSTRACT

A variety of methods, systems, and compositions are disclosed, including, in one embodiment, an additive manufacturing composition comprising an Fe—Cr—Ni alloy and a niobium-absorption element, wherein the Fe—Cr—Ni alloy has a niobium content of about 0.5% to about 5% by weight, wherein the niobium-absorption element forms a precipitate with niobium.

### CROSS-REFERENCE TO RELATED APPLICATION

This application claims priority to and the benefit of U.S. Provisional Application No. 63/586,754 having a filing date of Sep. 29, 2023, the disclosure of which is incorporated herein by reference in its entirety.

### FIELD

This application relates to metal alloy compositions and methods of manufacture. Specifically, example embodiments of this application relate to ferritic and Fe—Cr—Ni alloys. More specifically, example embodiments of this application relate to niobium-absorption elements included in metal alloys during additive manufacturing.

### BACKGROUND

Various manufacturing methods have been developed over many years for constructing articles of manufacture, i.e., “parts.” Manufacturing methods whose development accelerated during the industrial revolution include, for example, casting, forging, extruding, and machining. Often, more than one of these methods may be used to form a particular part. Casting involves melting a parent material, such as a plastic or metal alloy, and pouring the molten material into a mold having a desired part shape. Forging involves applying a large force and/or pressure to a solid (non-molten) workpiece to advance the workpiece toward a desired final part shape. Extruding involves forcing a workpiece through a die to form an elongated structure, such as a tubing or beam shape. Machining, sometimes referred to as subtractive manufacturing, involves selectively removing material from a workpiece (e.g., billet) using cutting tools to achieve a desired part shape within specified tolerances. These manufacturing methods have also been automated to some extent in recent decades. For example, computer numerical control (CNC) is now commonly used to automate the machining of parts.

One of the latest developments in manufacturing has been additive manufacturing, frequently referred to as three-dimensional (3D) printing. In contrast with subtractive processes, like machining, additive manufacture generally involves forming a part incrementally by depositing material in a controlled fashion. Typically, this process is controlled by a computer according to a computer-aided design (CAD) model containing a computer representation of the desired part shape. Additive manufacturing may refer to a variety of processes in which material is deposited, joined or solidified under computer control, typically layer by layer. Additive manufacturing is useful for many reasons, including the ability to automate manufacturing and to form part shapes that may otherwise be difficult or impossible to form purely by subtractive machining. However, an ongoing challenge with additive manufacturing is trying to achieve acceptable material properties that are comparable to what can be achieved with other manufacturing methods.

### SUMMARY

Disclosed herein is an example an additive manufacturing composition comprising an Fe—Cr—Ni alloy and a niobium-absorption element, wherein the Fe—Cr—Ni alloy has a niobium content of about 0.5% to about 5% by weight, wherein the niobium-absorption element forms a precipitate with niobium.

Disclosed herein is an additive manufacturing method, comprising: sequentially forming each layer of a plurality of layers of a three-dimensional part, and niobium, each layer comprising iron, chromium, nickel, and niobium, wherein the niobium is present in each layer in an amount of about 0.5% to about 5% by weight; wherein forming each layer comprises liquefying the layer, introducing a niobium-absorption element to absorb at least some of the niobium, and allowing the layer to solidify.

Further disclosed herein is an example additive manufactured apparatus comprising: a plurality of layers, each layer comprising iron, chromium, nickel, niobium, and a precipitate of the niobium and a niobium-absorption element, wherein the niobium is present in each of the layers in an amount of about 0.5% to about 5% by weight.

These and other features and attributes of the disclosed compositions, methods, and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a schematic diagram of an additive manufacturing system for implementing aspects of this disclosure in accordance with certain embodiments of the present disclosure.

FIG. 2 is a schematic diagram of an example process of forming a heterogeneous metal alloy in accordance with certain embodiments of the present disclosure.

FIG. 3 is a graph illustrating a desirable reduction in delta-T when supplying a niobium-absorption element during additive manufacturing of a niobium-containing alloy in accordance with certain embodiments of the present disclosure.

FIG. 4 is an optical and a SEM image of an as-printed HP16Nb showing evidence of intergranular cracks in accordance with certain embodiments of the present disclosure.

### DETAILED DESCRIPTION

Disclosed herein are methods and compositions for additive manufacturing with alloys that use niobium (Nb) as a stabilizing element. In particular, the disclosure focuses on alloys of iron, chromium, and nickel, i.e., Fe—Cr—Ni alloy. Plain carbon steel is sometimes used in industrial applications. However, most of its use is limited to 600-650° F. (316-343° C.) due to loss of strength and susceptibility to oxidation and other forms of corrosion at higher temperatures. Ferritic alloys, with additions consisting primarily of chromium (0.5-9%) and molybdenum (0.5-1%), are suitable for higher temperatures up to 1200° F. (650° C.). However, these low alloys have inadequate corrosion resistance to certain elevated temperature environments, for which more highly alloyed Ni—Cr—Fe alloys are required. Fe—Cr—Ni alloys have particular utility, for example, in refineries and petrochemical plants, and are desirable for use in pressure vessels, piping, fittings, valves and other equipment.

Ni—Cr—Fe alloys benefit from the addition of niobium as a stabilizing element. However, the use of Ni—Cr—Fe alloy has traditionally been limited to wrought and cast products. Additive manufacturing of Fe—Cr—Ni has previously not been practical when using niobium. The presence of niobium is generally not an issue when casting an Fe—Cr—Ni alloy, since the alloy cools in a relatively large mass. However, this disclosure has identified that, in additive manufacturing involving relatively thin layers of molten material, the presence of Nb may increase the solidus/liquidus temperature differential (delta T) and lead to cracking during cooling. This disclosure provides methods and compositions that include solutions for incorporating an element like niobium as a stabilizing element into the 3D-printed Fe—Cr—Ni alloy without undermining the additive manufacturing (i.e., 3D-printing) process.

In particular, example embodiments use a niobium-absorption element for the additive manufacturing of Fe—Cr—Ni alloys. The niobium-absorption element reduces the delta-T by drawing out some of the Nb in the current molten layer into a separate phase during solidification. The reduced delta T in the molten layer makes the material less susceptible to cracking during cooling. The niobium nevertheless remains in the as-finished alloy to provide desirable stability to the Fe—Cr—Ni alloy.

A small number of preferred niobium-absorption elements are disclosed. These niobium-absorption elements can be used alone, or possibly, in combination. Of the disclosed variants, nitrogen is generally the most preferred. Nitrogen may be introduced in excess of any current HPNB alloy specifications. Nitrogen is also portable and can be introduced in a gaseous (N₂) phase. Additionally, by modifying the partial pressure of nitrogen during additive manufacturing, its content can be modified on-the-fly. Another possible niobium-absorption element that may be used in at least some embodiments is carbon (C). The carbon may be added in solid form. The carbon may also be added in excess of existing HPNB alloy windows. For example, HP45Nb has a nominally 0.45 wt. % C, with additional C added as a niobium-absorption element for crack mitigation during additive manufacturing, in addition to potentially increasing creep strength in the as-formed alloy. A third example of a niobium-absorption element is silicon (Si). For example, Si can form high temperature compounds like Nb3Si that precipitate to reduce the niobium present in the molten layer during solidification.

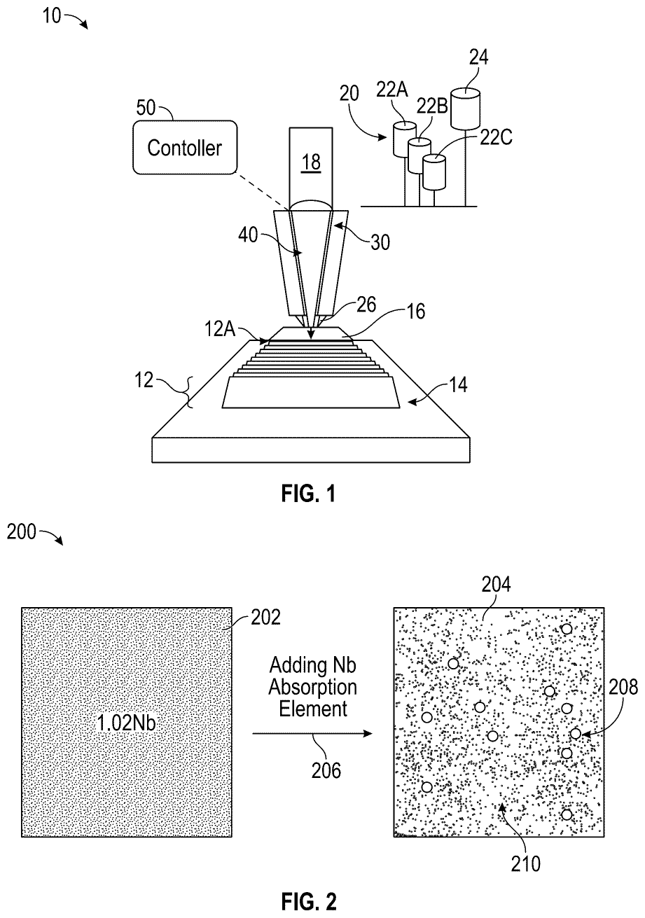

FIG. 1 is a schematic diagram of an example of an additive manufacturing system 10 for implementing aspects of this disclosure. Additive manufacturing in this context generally refers to forming a three-dimensional object by sequentially forming successive layers of material. These techniques generally involve the use of a laser to melt material in a given layer. The additive manufacturing may comprise, for example, aspects of laser powder bed fusion (LPBF). LPBF is an additive manufacturing process that uses a laser to melt thin layers of powder. Once the layer is solidified, a new powder layer is spread, and the process repeats until the part is created. In another example, the additive manufacturing may comprise laser metal deposition (LMD). LMD is an additive manufacturing process which uses a laser beam to form a melt pool on a metallic substrate, into which powder is fed. The powder melts to form a deposit that is fusion bonded to the substrate.

The additive manufacturing system 10 of FIG. 1 is genericized in order to cover any of a variety of additive manufacturing processes, including but not limited to LPBF and LMD. The additive manufacturing system 10 includes a powder supply 20, a powder delivery nozzle 30 in communication with the powder supply 20, a computer-controllable laser 40, and a controller 50 in communication with the computer-controllable laser 40 and other components. The powder supply 20 may comprise main alloying elements 22A, 22B, 22C, etc., such as nickel, chromium, and iron used in a Ni—Cr—Fe alloy, along with niobium as a stabilization element for the Ni—Cr—Fe alloy. The powder delivery nozzle 30 may be used to dispense the constituents of the alloy in a controlled fashion, incrementally, such as in sequentially formed layers 12 of a workpiece 14 being manufactured. The computer-controllable laser 40 may be used to supply energy to heat and liquefy the powder in a present working layer 12A. In LPBF, for example, the working layer 12A is liquefied and solidified before a next powder layer is spread, and the process repeats until the part is created. In LMD, similarly, the computer-controllable laser 40 may be applied to the present working layer 12A of material to form a melt pool on a metallic substrate 16, into which the powder stream is fed. Both the laser beam and powder stream may be delivered remotely.

A separate absorption element supply 24 of a niobium-absorption element is also provided. The niobium-absorption element may comprise, for example, pressurized N₂ gas whose supply (e.g., volumetric flow rate) could be controlled by controller 50 using any suitable volumetric control element such as a controllable valve. Alternatively, the niobium-absorption element may comprise carbon or silicon in solid (e.g., powder) form. The niobium-absorption element in any of these examples could be provided from the absorption element supply 24 at a controllable rate, independently from the supply of the main alloying elements 22A, 22B, 22C.

A shielding gas 26 may also be provided, such as of carbon dioxide and/or argon, during the melting step to protect the area from atmospheric gases that could compromise the quality of the formed working layer 12A. The computer-controllable laser 40, the powder supply 20, and the shielding gas 26 may all be simultaneously emitted from a single control head 18. Movement of the control head 18 in coordination with the computer-controllable laser 40 and the powder supply 20 may all be controlled by the controller 50. Depending, among other things, on the diameter of the laser beam emitted, more than multiple passes of the computer-controllable laser 40 may be required. In the case of LMD, the control head 18 may travel along a seam for welding through multiple passes in a lengthwise direction or it may travel along the seam for welding in a zig-zag pattern to form the LMD weldment to the seam. The power of the laser beam may be controlled as needed.

Motion control for the deposited layers 12 may be governed by control logic (e.g., firmware, software) residing in the controller 50 to generate a 3D part from CAD files. Using motion control for the deposit build, the powder stream fed to the process may be varied in the x, y and z directions to build a 3-dimensional part. Each layer 12 of the workpiece 14 may be individually formed in an X-Y plane, whereas each successive layer 12 of the workpiece 14 advances in the Z-direction. Thus, each layer 12 of workpiece 14 may be individually formed according to the cross-sectional shape of the 3D part file at the particular Z-axis location.

Workpiece 14 may be, for example, an oil, gas and/or petrochemical component that benefits from the mechanical properties (e.g., elevated-temperature strength, corrosion resistance, reduced cracking, higher creep strength) of a Ni—Cr—Fe or ferritic alloy. The Ni—Cr—Fe or ferritic alloy of each layer 12 and of the finished workpiece 14 overall may comprise the main alloying elements 22A, 22B, 22C, etc., such as nickel, chromium, and iron, along with the niobium-absorption element for stabilization of the finished part. The layers 12 and finished workpiece 14 may also include the precipitate formed by the niobium and niobium-absorption element. Some of the niobium may precipitate out of the present working layer 12A while it is molten. Despite the formation of precipitates, the weight percentage of elemental niobium present in the final composition of the cooled layers 12 and the workpiece 14 overall is preserved (e.g., between 0.5% and 5% by weight niobium, or any ranges therebetween). As such, the finished workpiece 14 once cooled may still have all of the stabilizing benefits of niobium. However, the addition of the niobium-absorption element when forming each layer 12 ensures structural properties of the workpiece 14 are improved as compared with additive manufacturing of the alloy without the niobium-absorption element. Those structural properties may be on par with the structural properties of cast niobium-stabilized Ni—Cr—Fe alloys, as will be demonstrated in examples below. It is noted that in some examples, 5 wt. % may be a practical upper limit of Nb in Fe—Ni—Cr alloy systems as brittle phases may form at higher Nb concentrations, causing the material properties to deteriorate in some examples.

FIG. 2 is a schematic diagram of an example process 200 for forming a heterogeneous metal alloy 204 comprising an external niobium-depleted phase 210 and internal niobium-rich phase 208 from a homogenous phase 202 prior to solidification during additive manufacturing. As illustrated, depletion of niobium in a heterogeneous metal alloy 204 during step 206 may occur as a result of contacting a homogenous phase 202 with the niobium-absorption element. Niobium may be present in homogenous phase 202 in an amount of, for example, 1.02 wt. %. Alternatively, from 0.8 wt. % to 1.3 wt. % or any ranges therebetween. Niobium may be homogenously distributed throughout homogenous phase 202 or essentially homogenously distributed there throughout. As mentioned, the niobium-absorption element may comprise nitrogen, nitrogen gas (N₂), carbon (e.g., black carbon), iron nitrite, silicon, and any combinations thereof. Upon contacting the niobium-absorption element with homogenous phase 202, the niobium and niobium-absorption element in homogenous phase 202 may conglomerate to form an internal niobium-rich phase 208 and an external niobium-depleted phase 210. Contacting of the niobium-absorption element and homogenous phase 202 may comprise, in some examples, alloying of homogenous phase 202 with the niobium-absorption element at a high temperature (e.g., 1300° C. and above). Niobium may be present in the internal niobium-rich phase 208 in an amount of, for example, less than 1.02 wt. %. Alternatively, from 0 wt. % to 1.02 wt. % or any ranges therebetween. Internal niobium-rich phase 208 may be stable at high temperatures.

The niobium-absorption element may be present in a heterogeneous metal alloy 204 comprising the two phases or the internal niobium-rich phase 208 in an amount greater than 1500 ppm, for example, from 1500 ppm to 1600 ppm. Alternatively, from 100 ppm to 1600 ppm, or any ranges therebetween. In some examples, it may be desirable to maintain concentration of the niobium-absorption element in the internal niobium-rich phase 208 below the solubility limit of the niobium-absorption element in the metal alloy. For example, where the niobium-absorption element comprises nitrogen, concentration in excess of the solubility of nitrogen in the metal alloy may result in bubbles which could compromise the strength of heterogeneous phase 204 once solidified.

Heterogeneous phase 204 may initially have a high temperature immediately following contact between the niobium-absorption element and homogenous phase 202. Forming of the two phases may begin to occur as soon as the contacting begins and may continue to occur until heterogeneous phase 204 is completely solidified, at which point internal niobium-rich phase 208 may be heterogeneously distributed throughout external niobium-depleted phase 210. Niobium may be present in internal niobium-rich phase 208 in an amount of, for example, greater than 0.8 wt. % and in some examples, greater than 1.3 wt. %.

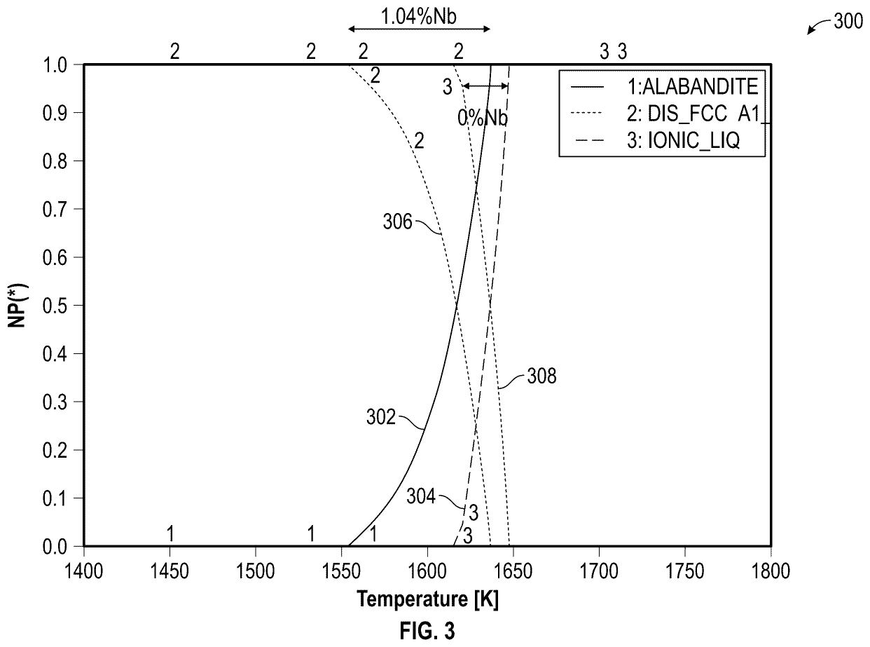

FIG. 3 is a graph 300 illustrating a desirable reduction in delta-T when supplying a niobium-absorption element during additive manufacturing of a niobium-containing (e.g., Fe—Cr—Ni) alloy according to aspects of this disclosure. Line 302 represents the liquidus of a nominal HP16Nb composition with 1.04 wt. % niobium, and line 304 represents the liquidus of a nominal HP16Nb composition without niobium. Line 306 represents the solidus of a nominal HP16Nb composition with 1.04 wt. % niobium, and line 308 represents the solidus of a nominal HP16Nb composition without niobium. The delta-T between liquidus and solidus of the HP16Nb composition with 1.04 wt. % niobium is greater than the delta-T between liquidus and solidus of the HP16Nb composition without niobium. The result is that by including niobium in a metal alloy, the delta-T of the metal alloy is increased. Conversely, by decreasing the amount of niobium in a metal alloy, the delta-T is decreased. Inclusion of the niobium-absorption element in the metal alloy may thus allow external niobium-depleted phase 210 (e.g., referring to FIG. 2) to transition from a liquid phase to a solid phase over a smaller delta-T as compared to a metal alloy without the niobium-absorption element.

Macroscopic properties resulting from the relationship between concentration of niobium and delta-T shown in FIG. 3 may include, for example, an overall reduction in the amount of cracking of heterogeneous phase 204 once solidified as compared to the same solidified metal alloy without the niobium-absorption element. Without being limited by theory, it is believed that this effect may be attributed to a slight increase in the overall ductility of the metal alloy during solidification due to the smaller delta-T of the external niobium-depleted phase. Other macroscopic properties resulting from these and other factors (e.g., presence of niobium in the as-formed alloy) may include, for example, higher creep strength in an as-formed alloy, good mechanical strength at high temperatures, and good corrosion resistance.

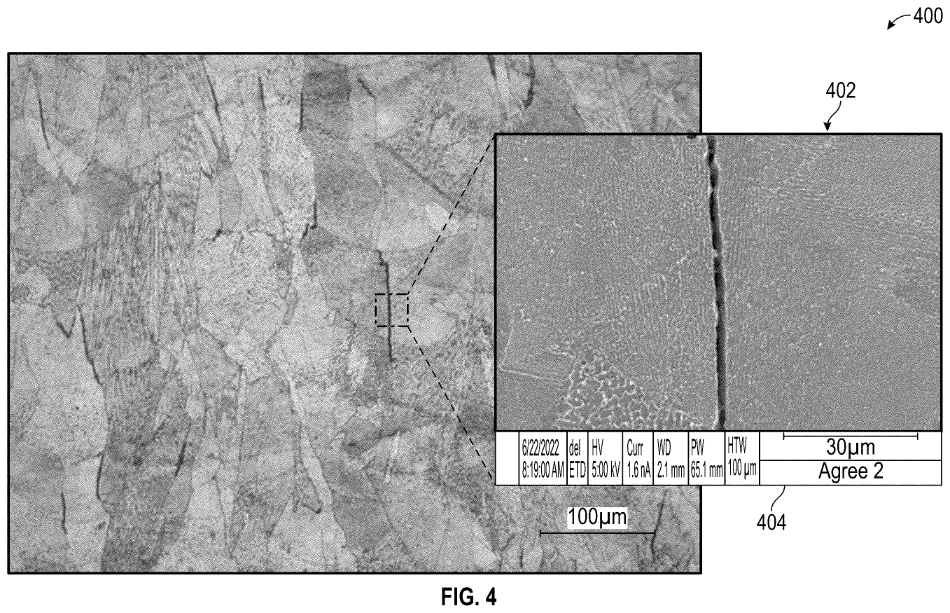

FIG. 4 is an optical image 400 and an SEM image 402 of an as-printed HP16Nb (without a niobium-absorption element) showing evidence of intergranular cracks 404. As shown, one or more intergranular cracks 404 may form during solidification of a metal alloy. The forming of one or more intergranular cracks 404 in a heterogeneous phase 204 (e.g., referring to FIG. 2) may be prevented or mitigated by the inclusion of niobium-absorption element due to the effects discussed in the foregoing.

### Additional Embodiments

Accordingly, the present disclosure may provide compositions and methods of manufacturing said compositions, the said compositions comprising a niobium-absorption element. The compositions and methods may include any of the various features disclosed herein, including one or more of the following statements.

Statement 1. An additive manufacturing composition comprising an Fe—Cr—Ni alloy and a niobium-absorption element, wherein the Fe—Cr—Ni alloy has a niobium content of about 0.5% to about 5% by weight, wherein the niobium-absorption element forms a precipitate with niobium.

Statement 2. The additive manufacturing composition of Statement 1, wherein the Fe—Cr—Ni alloy comprises a powder including iron, chromium, and nickel alloying elements.

Statement 3. The additive manufacturing composition of Statement 2, wherein the niobium-absorption element comprises at least one element selected from the group consisting of nitrogen, carbon, silicon, and combinations thereof, and wherein the niobium-absorption element is initially separate from the iron, chromium, and nickel alloying elements.

Statement 4. The additive manufacturing composition of Statement 3, wherein the niobium-absorption element comprises nitrogen gas.

Statement 5. The additive manufacturing composition of Statement 3, wherein the niobium-absorption element comprises solid carbon.

Statement 6. The additive manufacturing composition of Statement 5, wherein the powder further comprises carbon, and wherein the solid carbon of the niobium-absorption element is initially separate from the carbon of the powder.

Statement 7. An additive manufacturing method, comprising: sequentially forming each layer of a plurality of layers of a three-dimensional part, each layer comprising iron, chromium, nickel, and niobium, wherein the niobium is present in each layer in an amount of about 0.5% to about 5% by weight; wherein forming each layer comprises liquefying the layer, introducing a niobium-absorption element to absorb at least some of the niobium, and allowing the layer to solidify.

Statement 8. The additive manufacturing method of Statement 7, wherein absorbing at least some of the niobium comprises forming a niobium precipitate from the niobium and the niobium-absorption element while the layer is liquefied.

Statement 9. The additive manufacturing method Statement claim 8, wherein the layer includes the niobium precipitate upon solidification.

Statement 10. The additive manufacturing method of any one of Statements 7 to 9, wherein the niobium-absorption element comprises at least one element selected from the group consisting of nitrogen, carbon, silicon, and combinations thereof, wherein the niobium-absorption element is initially separate from the iron, chromium, and nickel alloying elements.

Statement 11. The additive manufacturing method of any one of Statements 7 to 9, wherein the niobium-absorption element comprises nitrogen.

Statement 12. The additive manufacturing method of Statement 11, wherein introducing the niobium-absorption element comprises supplying a nitrogen gas to the layer while liquefied.

Statement 13. The additive manufacturing method of Statement 12, further comprising adjusting a partial pressure of the nitrogen gas supplied to the layer.

Statement 14. The additive manufacturing method of any one of Statements 7 to 9, wherein the niobium-absorption element comprises at least one element selected from the group consisting of carbon, silicon, and combinations thereof.

Statement 15. The additive manufacturing method of any one of Statements 7 to 14, further comprising liquefying the layer with a laser.

Statement 16. The additive manufacturing method of Statement 15, wherein liquefying the layer with the laser comprises using laser powder bed fusion (LPBF) or laser metal deposition (LMD) to liquefy the layer.

Statement 17. An additive manufactured apparatus comprising: a plurality of layers, each of the layers comprising iron, chromium, nickel, niobium, and a precipitate of the niobium and a niobium-absorption element, wherein the niobium is present in each of the layers in an amount of about 0.5% to about 5% by weight.

Statement 18. The additive manufactured apparatus of Statement 17, wherein the niobium-absorption element comprises nitrogen.

Statement 19. The additive manufactured apparatus of Statement 18, wherein the precipitate comprises at least one precipitate selected from the group consisting of NbC, NbN and NbSi2.

Statement 20. The additive manufactured apparatus of Statement 17, wherein the niobium-absorption element comprises at least one element selected from the group consisting of carbon, silicon, and combinations thereof.

To facilitate a better understanding of the present invention, the following examples of certain aspects of some embodiments are given. In no way should the following examples be read to limit, or define, the entire scope of the disclosure.

### EXAMPLES

### Example 1

An example alloy that presents challenges to 3D printing is HP16Nb. The nominal composition of HP16Nb high resistant cast alloy(in wt %) is as follows.

TABLE 1

| C | Si | Cr | Mn | Fe | Ni | Nb | N |
|---|---|---|---|---|---|---|---|
| 0.13-0.19 | 1.2-1.7 | 23.5-25.0 | 1.15-1.75 | Bal. | 36.5-38.0 | 0.8-1.3 | 0.15< |

HP16Nb is a representative Ni—Cr—Fe alloy being developed for use at elevated temperature where relatively severe mechanical stresses are encountered and high surface stability is required. The structure of Ni—Cr—Fe alloys consist of the primary phase of γ austenitic FCC matrix, plus a variety of secondary phases, which are the metal carbides denoted by the compound MxC such as MC and M23C6 (M=Metals, C=carbide). The additions of niobium to the alloy were able to increase their resistance to thermal shock, while the niobium acts as a carbide stabilizer.

An initial trial of HP16Nb powder using Laser Powder Bed Fusion (LPBF) with various laser energy inputs shows that high level of relative density can be achieved (˜99.97%) but the as-printed couples have intergranular cracks. Lowering laser energy input can reduce the number of cracks per unit area but not be able to totally eliminate them, which indicates that the HP16Nb is intrinsically cracking susceptible during LPBF processing.

Therefore, HP16Nb is a candidate for using the disclosed methods to achieve 3D printable HP16Nb. The challenge includes minimizing niobium in the matrix during solidification. Directly reducing niobium content in the as-finished alloy may reduce the strength. Instead, the disclosed methods may entail alloying the HP16Nb with additional niobium-absorption elements, like N, C, and or Si, to react with Nb at high temperature (e.g., 1300 C) to thus reduce niobium content in matrix by forming precipitates. For example, nitrogen (N₂) may be added in excess of the specification above.

### Example 2

A higher nitrogen version HP16Nb was then fabricated using N2 gas atomization. The as obtained powder has 1800 ppm N. During LPBF, argon (Ar) was used as protection gas. The nitrogen content in as-print couple is 1600 ppm, which is slightly higher than the cast HP16Nb specification but below the nitrogen-solubility limit. Since the solution segregation of LPBF is much less than that of casting, the slightly higher nitrogen content does not lead to measurable N2 gas bubble formation in the LPBF product and subsequent welding. The 3D-printed HP16Nb with high nitrogen content shows the same level of high relative density and no intergranular cracking. The further mechanical tests show superior properties as compared with the cast counterpart.

TABLE 2

| | As-Cast | As-print |
|---|---|---|
| Porosity | 2% | 0.03% |
| Grain size | 9 mm | 100 um |
| Ys (Mpa) | 185 | 654 |
| UTS (Mpa) | 448 | 910 |
| Elongation (%) | 20 | 30 |

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. An additive manufacturing composition comprising an Fe—Cr—Ni alloy and a niobium-absorption element, wherein the Fe—Cr—Ni alloy has a niobium content of about 0.5% to about 5% by weight, wherein the niobium-absorption element forms a precipitate with niobium.

2. The additive manufacturing composition of claim 1, wherein the Fe—Cr—Ni alloy comprises a powder including iron, chromium, and nickel alloying elements.

3. The additive manufacturing composition of claim 2, wherein the niobium-absorption element comprises at least one element selected from the group consisting of nitrogen, carbon, silicon, and combinations thereof, and wherein the niobium-absorption element is initially separate from the iron, chromium, and nickel alloying elements.

4. The additive manufacturing composition of claim 3, wherein the niobium-absorption element comprises nitrogen gas.

5. The additive manufacturing composition of claim 3, wherein the niobium-absorption element comprises solid carbon.

6. The additive manufacturing composition of claim 5, wherein the powder further comprises carbon, and wherein the solid carbon of the niobium-absorption element is initially separate from the carbon of the powder.

7. An additive manufacturing method, comprising:
sequentially forming each layer of a plurality of layers of a three-dimensional part, each layer comprising iron, chromium, nickel, and niobium, wherein the niobium is present in each layer in an amount of about 0.5% to about 5% by weight; and
wherein forming each layer comprises liquefying the layer, introducing a niobium-absorption element to absorb at least some of the niobium, and allowing the layer to solidify.

8. The additive manufacturing method of claim 7, wherein absorbing at least some of the niobium comprises forming a niobium precipitate from the niobium and the niobium-absorption element while the layer is liquefied.

9. The additive manufacturing method of claim 8, wherein the layer includes the niobium precipitate upon solidification.

10. The additive manufacturing method of claim 7, wherein the niobium-absorption element comprises at least one element selected from the group consisting of nitrogen, carbon, silicon, and combinations thereof, wherein the niobium-absorption element is initially separate from the iron, chromium, and nickel alloying elements.

11. The additive manufacturing method of claim 7, wherein the niobium-absorption element comprises nitrogen.

12. The additive manufacturing method of claim 11, wherein introducing the niobium-absorption element comprises supplying a nitrogen gas to the layer while liquefied.

13. The additive manufacturing method of claim 12, further comprising adjusting a partial pressure of the nitrogen gas supplied to the layer.

14. The additive manufacturing method of claim 7, wherein the niobium-absorption element comprises at least one element selected from the group consisting of carbon, silicon, and combinations thereof.

15. The additive manufacturing method of claim 7, further comprising liquefying the layer with a laser.

16. The additive manufacturing method of claim 15, wherein liquefying the layer with the laser comprises using laser powder bed fusion (LPBF) or laser metal deposition (LMD) to liquefy the layer.

17. An additive-manufactured apparatus comprising:
a plurality of layers, each of the layers comprising iron, chromium, nickel, niobium, and a precipitate of the niobium and a niobium-absorption element, wherein the niobium is present in each of the layers in an amount of about 0.5% to about 5% by weight.

18. The additive-manufactured apparatus of claim 17, wherein the niobium-absorption element comprises nitrogen.

19. The additive-manufactured apparatus of claim 18, wherein the precipitate comprises at least one precipitate selected from the group consisting of NbC, NbN and NbSi2.

20. The additive-manufactured apparatus of claim 17, wherein the niobium-absorption element comprises at least one element selected from the group consisting of carbon, silicon, and combinations thereof.
